(19) United States
(12) Patent Application Publication
(10) Pub. No.: US 2025/0212103 A1
(43) Pub. Date: Jun. 26, 2025

(54) CORE NETWORK NODE, USER EQUIPMENT AND METHODS IN A WIRELESS COMMUNICATION NETWORK

(71) Applicant: Telefonaktiebolaget LM Ericsson (publ), Stockholm (SE)

(72) Inventors: George Foti, Dollard des Ormeaux (CA); Peter Hedman, Helsingborg (SE)

(21) Appl. No.: 18/849,371

(22) PCT Filed: Mar. 3, 2023
(86) PCT No.: PCT/SE2023/050192

§ 371 Date: Sep. 20, 2024

Related U.S. Application Data
(60) Provisional application No. 63/269,837, filed on Mar. 24, 2022.

(51) Int. Cl. H04W 48/18

(52) U.S. Cl. CPC H04W 48/18

(57) ABSTRACT

A method performed by a core network node is provided. The method is for handling one or more rules for a User Equipment, UE, in a network. The core network node is operating in the network. The network is comprised in a wireless communications network. The core network node receives (201) capability data from the UE. The capability data relates to the UE's capabilities to support rules for use of one or more network slices. The core network node obtains (203) one or more rules relating to a use of one or more network slices allowed in the network. The core network node decides (204) that the UE is capable to support rules for use of one or more network slices in the network according to the one or more rules, based on the received capability data and the obtained one or more rules. The core network node sends (205) to the UE, the one or more rules that the UE is capable to support, and where the one or more rules are to be applied by the UE for use of one or more network slices in the network. The core network node enforces (206) the one or more rules relating to the of use of one or more network slices applied by the UE in the network.

### TECHNICAL FIELD

Embodiments herein relate to a core network node, a User Equipment (UE) and methods therein. In some aspects, they relate to handling one or more rules for a UE in a network of a wireless communications network.

### BACKGROUND

In a typical wireless communication network, wireless devices, also known as wireless communication devices, mobile stations, stations (STA) and/or User Equipments (UE) s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specifying the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHZ. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

Existing policies sent to a UE e.g. in UE Route Selection Policy (URSP), e.g. as in 3GPP TS 23.501 V17.3.0 and 23.503 V17.3.0, on how to use network slices are related to the Home Public Land Mobile Network (HPLMN) Single Network Slice Selection Assistance Information (S-NSSAI), and URSP rules in relation to Protocol Data Unit (PDU) Sessions does not indicate when PDU Sessions are to be available and used. Also, URSP rules are provided by HPLMN while they are applicable to all Public Land Mobile Networks (PLMNs), i.e. same set of rules are used by the UE when in HPLMN and when roaming in Visited PLMNs (VPLMNs).

When the UE is roaming in a VPLMN, the VPLMN may be able to offer different network slices for supporting the services wanted by the UE and network slices used by the HPLMN. The VPLMN can currently only use one specific network slice to be used in the VPLMN for a specific HPLMN network slice, and there is no means for the VPLMN to indicate to the UE what the expectations are for the UE when the UE is in the VPLMN.

### SUMMARY

As a part of developing embodiments herein the inventors identified a problem which first will be discussed.

There is a need for VPLMN to control how its slices can be used efficiently and effectively by inbound roamers. Improper use by UE to network slices may lead to congestion and potential bottlenecks.

An object of embodiments herein is to improve the performance in a wireless communications network using network slices.

According to an aspect, the object is achieved by a method performed by a core network node. The method is for handling one or more rules for a User Equipment, UE, in a network. The core network node is operating in the network. The network is comprised in a wireless communications network. The core network node receives capability data from the UE. The capability data relates to the UE's capabilities to support rules for use of one or more network slices. The core network node obtains one or more rules relating to a use of one or more network slices allowed in the network. The core network node decides that the UE is capable to support rules for use of one or more network slices in the network according to the one or more rules, based on the received capability data and the obtained one or more rules. The core network node sends to the UE, the one or more rules that the UE is capable to support, and where the one or more rules are to be applied by the UE for use of one or more network slices in the network. The core network node enforces the one or more rules relating to the of use of one or more network slices applied by the UE in the network.

According to an aspect, the object is achieved by a method performed by a User Equipment, UE. The method is for handling one or more rules in a network. The network is comprised in a wireless communications network. The UE sends capability data to a core network node operating in the network. The capability data relating to the UE's capabilities to support rules relates to a use of one or more network slices. The UE receives from the core network node, one or more rules relating to the of use of one or more network slices. The core network node has decided that the UE is capable to support the one or more rules based on the sent capability data and one or more rules allowed in the network. The UE then stores and applies the received one or more rules in the network.

According to another aspect, the object is achieved by a core network node. The core network node is configured to handle one or more rules for a User Equipment, UE, in a network. The core network node is operable in the network. The network is adapted to be comprised in a wireless communications network. The core network node is further configured to:
Receive capability data from the UE, which capability data is adapted to relate to the UE's capabilities to support rules for use of one or more network slices,
obtain one or more rules relating to a use of one or more network slices allowed in the network,
decide that the UE is capable to support rules for use of one or more network slices in the network according to the one or more rules, based on the received capability data and the obtained one or more rules,
send to the UE, the one or more rules that the UE is capable to support, which one or more rules are adapted to be applied by the UE for use of one or more network slices in the network, and
enforce the one or more rules relating to the of use of one or more network slices applied by the UE in the network.

According to another aspect, the object is achieved by a User Equipment, UE. The UE is configured to handle one or more rules in a network. The network is adapted to be comprised in a wireless communications network. The UE is further configured to:
send to a core network node operating in the network, capability data relating to the UE's capabilities to support the use of rules related to the use of one or more network slices,
receive, from the core network node, one or more rules relating to the of use of one or more network slices, which one or more rules are adapted to have been decided that the UE is capable to support, which one or more rules are adapted to be decided based on the sent capability data and one or more rules allowed in the network, and
store and apply the received one or more rules in the network.

Advantages with the above methods according to embodiments herein, in the core network node and in the UE, are that the network is able to control the use of its slices by inbound roamers to ensure to ensure efficiency minimize the possibility of congestion and potential bottlenecks.

### BRIEF DESCRIPTION OF THE DRAWINGS

FIG. 1 is a schematic block diagram depicting embodiments of a wireless communications network.

FIG. 2 is a flow chart depicting embodiments of a method performed by a core network node.

FIG. 3 is a flow chart depicting embodiments of a method performed by a UE.

FIG. 4 is a sequence diagram depicting embodiments of methods herein.

FIGS. 5 a and b are schematic block diagrams depicting embodiments of a core network node.

FIGS. 6 a and b are schematic block diagrams depicting embodiments of a UE.

FIG. 7 schematically illustrates a telecommunication network connected via an intermediate network to a host computer.

FIG. 8 is a generalized block diagram of a host computer communicating via a base station with a user equipment over a partially wireless connection.

FIGS. 9 to 12 are flowcharts illustrating methods implemented in a communication system including a host computer, a base station and a user equipment.

### DETAILED DESCRIPTION

Example of embodiments herein comprise enhancements comprised in one or more rules provided to a UE by a core network node in a network, e.g. in a VPLMN, a HPLMN, or an Standalone Non-Public Network (SNPN), enabling the UE to optimize slice usage, e.g. while being in a HPLMN not roaming, or while roaming in a VPLMN or an SNPN. The core network node e.g. in the VPLMN will enforce these rules to ensure UE compliance.

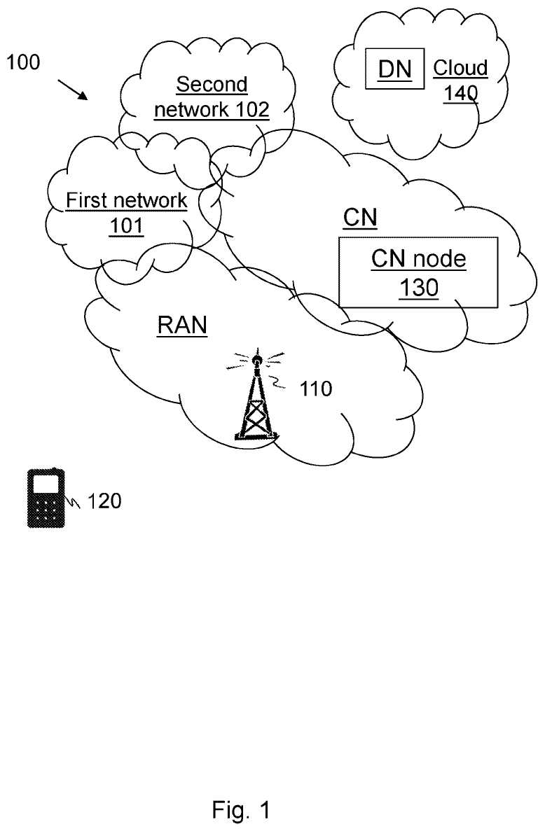

FIG. 1 is a schematic overview depicting a wireless communications network 100 wherein embodiments herein may be implemented. The wireless communications network 100 comprises one or more RANs and one or more CNs. The wireless communications network 100 may comprise a first network 101, which first network 101 is a network that is subscribed by a UE 120, e.g. a Home Public Land Mobile Network, (HPLMN) associated to a subscription of the UE 120.

The wireless communications network 100 further comprises a second network 102, which second network 102 is a network that is not subscribed by the UE 120, e.g. a Visited Public Land Mobile Network, (VPLMN) or a SNPN, that is not being associated to a subscription of the UE 120.

The embodiments herein may relate to a network 101, 102 e.g. being represented by any of the first network 101 or the second network 102. The wireless communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a RAN node 110 operate in the wireless communications network 100, by means of antenna beams, referred to as beams herein. The RAN node 110 e.g. provides a number of cells and may use these cells for communicating with e.g. a UE 120. The RAN node 110 may be a transmission and reception point e.g. a radio access network node such as a base station, e.g. a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the RAN node 110 depending e.g. on the radio access technology and terminology used.

User Equipments operate in the wireless communications network 100, such as the UE 120. The UE 120 may provide radio coverage by means of a number of antenna beams 127, also referred to as beams herein. The UE 120 may e.g. be an NR device, a mobile station, a wireless terminal, an NB-IoT device, an eMTC device, an NR RedCap device, a CAT-M device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

CN nodes such as a core network node 130 operates in the wireless communications network 100. The core network node 130 may e.g. be an Access and Mobility Management Function (AMF) node, e.g. operating in the network 101, 102, e.g. a VPLMN.

Methods herein may in one aspect be performed by the core network node 130, and in another aspect by the UE 120. As an alternative, a Distributed Node (DN) and functionality, e.g. comprised in a cloud 140 as shown in FIG. 1, may be used for performing or partly performing the methods.

Examples of embodiments herein relate to one or more rules, e.g. rules and policies, for network slice usage.

In some embodiments, policies and/or rules are provided to the UE 120, to guide the UE 120 how to use the network slices in the network 101, 102. The policies and/or rules are referred to as the one or more rules herein. These one or more rules may e.g. include time of day use, expected length of a PDU session, etc. In some embodiments, a Registration procedure and/or UE Configuration Update procedure are extended to support this capability.

It should be noted that a network slice use rules and policies that may be applicable to VPLMN and HPLMN as well even if this is not explicitly mentioned.

In some embodiments, the core network node 130, e.g. an AMF, returns to the UE 120, in a Registration Accept or in UE Configuration Update Command, the one or more rules, applicable to potentially each S-NSSAI of the Allowed NSSAI or Configured NSSAI. The one or more rules provide an expected usage for the network slices. The one or more rules may be e.g. configured in the core network node 130, fetched from Network Slice Selection Function (NSSF) or provided by the Visited Policy Control Function (V-PCF).

In the Registration Accept some rules are to be used for the network slices, S-NSSAIs, in the Allowed NSSAI, as well as the ability to map more than one S-NSSAI of the Configured NSSAI, i.e., S-NSSAI for the serving network or VPLMN, to a single HPLMN S-NSSAI.

In some embodiments, the UE 120 capabilities are extended to support the reception and processing of these one or more rules. The UE's 120 capabilities may be sent as part of the Registration Request to enable the core network node 130, e.g. the AMF, to ascertain whether to send or not the network slice usage one or more rules. The core network node 130, e.g. the AMF, may then enforce these network slice usage one or more rules regardless of, whether the UE 120 supports them or not to ensure proper utilization of its resources.

In addition the one or more rules may also include expectations of the handling of the PDU Sessions.

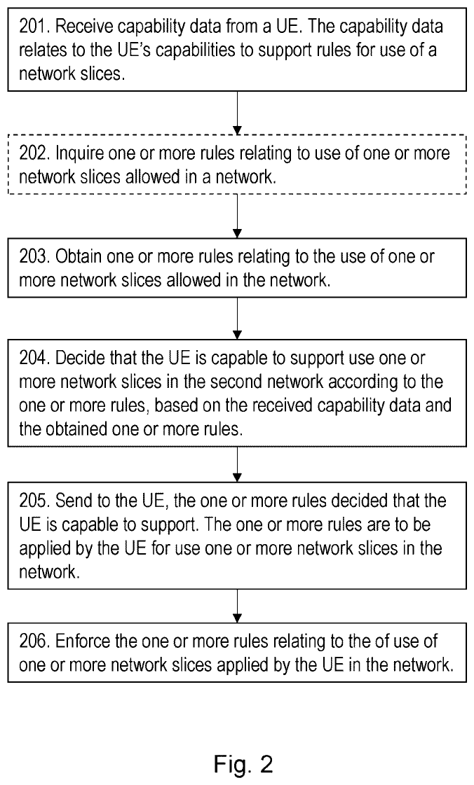

FIG. 2 shows an example method performed by the core network node 130, e.g. an AMF node. The method may be for handling one or more rules for the UE 120 in the network 101, 102. The core network node 130 is operating in the network 101, 102. The network 101, 102 is comprised in the wireless communications network 100.

The network 101, 102 may be represented by any one out of:
a Home Public Land Mobile Network, HPLMN,
a Visited Public Land Mobile Network, VPLMN, or
a Standalone Non-Public Network, SNPN.

The method comprises any one or more out of the actions listed below. Optional actions are presented in dashed boxes in FIG. 2.

### Action 201

The core network node 130 receives capability data from the UE 120. The capability data relates to the UE's 120 capabilities to support rules for use of network slices. Thus the capability data may relate to that the UE's 120 has capabilities to support rules for use for the network slices. This may be to inform the core network node 130 that the UE's 120 has the capabilities to support rules for use of network slices.

E.g., when the UE 120 registers in 5GS, the UE 120 includes its capabilities to support handling and processing of network slice usage policies and/or rules.

### Action 202

In some embodiments, the core network node 130 inquires, e.g., requests, the one or more rules relating to the use of the one or more network slices allowed in the network 101, 102. The one or more rules may e.g., be inquired from any one out of: a policy control node, e.g. a V-PCF, or a NSSF node.

### Action 203

The core network node 130 obtains the one or more rules relating to the use of one or more network slices allowed in the network 101, 102.

The one or more rules may be obtained from the corresponding any one out of: the policy control node or the NSSF node, e.g. as a response to the request is sent to any one out of: a policy control node, e.g. a V-PCF, or an NSSF node.

In some embodiments, the one or more rules are obtained by being configured in the core network node 130, e.g. preconfigured and/or configured by the core network node 130.

### Action 204

The core network node 130 decides that the UE 120 is capable to support rules for use of one or more network slices in the network 101, 102 according to the one or more rules. The decision is based on the received capability data and the obtained one or more rules. The core network node 130 may first check if the UE 120 is capable to support rules for use of one or more network slices in the network 101, 102 according to the one or more rules based on the received capability data and the obtained one or more rules.

### Action 205

The core network node 130 then sends to the UE 120, the one or more rules decided that the UE 120 is capable to support. The one or more rules are to be applied by the UE 120 for use of one or more network slices in the network 101, 102.

### Action 206

The core network node 130 enforces the one or more rules relating to the use of one or more network slices applied by the UE 120 in the network 101, 102, e.g. to ensure UE compliance. This e.g., means that in some embodiments, the core network node 130 such as its AMF has to ensure that the UE 120 follows the rules and detects if any of the rules are being violated, i.e. not being followed. For example, if a rule is set that the UE 120 always need to establish a PDU Session after registering a network slice, the core network node 130 such as its AMF monitors such that the UE 120 establishes a PDU Session directly after the UE 120 has registered a network slice, S-NSSAI. Another example, if a rule says that a PDU session over a specific network slice can be established for a maximum time of x hrs. Hence, the core network node 130, such as its AMF may monitor all PDU sessions established over that network slice to ensure compliance to this time restriction and PDU session duration. The core network node 130, such as its AMF may tear down PDU sessions not complying to the time restriction upon timer expiry.

The one or more rules and the time while the UE 120 is attached to the network 1101, 102 such as e.g., the VPLMN may be modified.

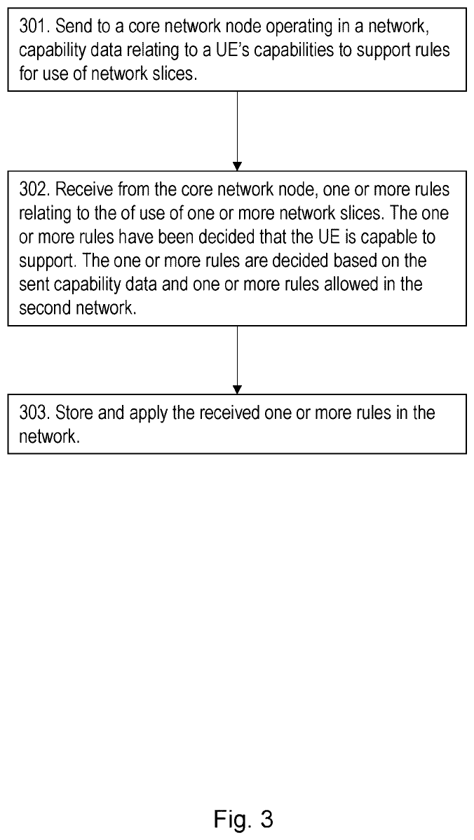

FIG. 3 shows an example method performed by the UE 120, e.g., for handling one or more rules in the network 101, 102. The network 101, 102 is comprised in the wireless communications network 100.

The network 101, 102 may be represented by any one out of:
a Home Public Land Mobile Network, HPLMN,
a Visited Public Land Mobile Network, VPLMN, or
a Standalone Non-Public Network, SNPN.

The method comprises any one or more out of the actions listed below.

### Action 301

The UE 120 sends capability data to the core network node 130 operating in the network 101, 102, e.g. an AMF node. The capability data relates to the UE's 120 capabilities to support rules related to a use of one or more network slices.

### Action 302

The UE 120 receives one or more rules from the core network node 130. The one or more rules relate to the use of one or more network slices.

The core network node 130 has decided that the UE 120 is capable of supporting the one or more rules based on the sent capability data and one or more rules allowed in the network 101, 102.

### Action 303

The UE 120 then stores and applies the received one or more rules in the network 101, 102. The one or more rules may be modified any time while the UE 120 is attached to the network 1101, 102 such as e.g., the VPLMN.

Advantages with the above methods according to embodiments herein, in the core network node 130 and in the UE 120, are that the network 101, 102 is able to control the use of its slices by inbound roamers to ensure to ensure efficiency minimize the possibility of congestion and potential bottlenecks.

The methods will now be further explained and exemplified in below embodiments. These below embodiments may be combined with any suitable embodiment as described above.

### UE Policies for Network Slice and PDU Session Use

In some embodiments, the UE 120 policies applicable to Network Slices usage in a VPLMN such as the one or more rules, are included as an additional element in a Registration Accept or UE Configuration Update Command. These one or more rules may comprise rules for using the network slices subject to applicable conditions to the rule. The one or more rules for using a slice may comprise the following information per network slice of a configured NSSAI or limited to network slices of an Allowed NSSAI. The one or more rules may also include rules related to Data Network Names (DNNs) of the network slices e.g. for how to handle the PDU Sessions.

The information below are just examples set per S-NSSAI, and for PDU Sessions per DNN or for all DNNs in the network 101, 102. The rules may also be sent to the UE 120 while the UE 120 is registered in the subscribed network e.g. HPLMN or subscribed SNPN.

### Requesting the Network Slice in the Network 101, 102 at Registration.

As mentioned above, the one or more rules may comprise rules for using the network slices subject to applicable conditions to the rule. The conditions may comprise one or more of the following:
Time of Day.
Location, e.g. when in this area e.g. in form of a set of Tracking Areas, or when not in this area e.g. always except when using these Tracking Areas,
Reason for request, such as when to be used immediately, when to be used later, or no conditions attached to requesting it i.e. slice is always to be requested if other conditions are met.

### PDU Session Establishment in the Network 101, 102.

Time of day
Location, e.g. when in this area e.g. in form of a set of Tracking Areas, or when not in this area e.g. always except when using these Tracking Areas,
List of DNN
Total Length of time the session can be used regardless of any activity.
Can be handed over to another access
PDU Idle Status, e.g. allowed for the PDU Session or allowed for the PDU Session without user data sent, or when there is no time limit associated with PDU session establishment, or when UE 120 in Radio Resource Control (RRC) idle (RRC_IDLE) and/or RRC Inactive (RRC_Inactive), or Connection Management (CM) idle (CM-IDLE).
Immediate tear down after use.
Idle Allowed for a limited time
Indefinite Idle Allowed (i.e. up to network when to release)

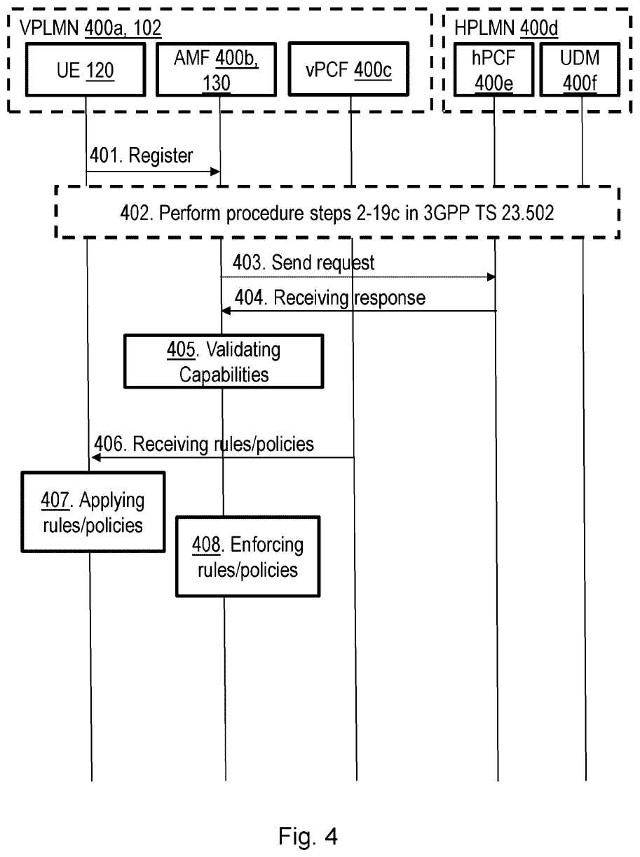

A sequence diagram depicted in FIG. 4 illustrates example embodiments of the methods described above for an inbound roamer. The same procedure may be used while the UE 120 is not roaming, and when the AMF, such as the network node 130, is registered in the subscribed network 101, e.g. HPLMN.

The steps in the sequence diagram may be performed in a VPLMN 400a, such as the second network 102, and HPLMN 400d such as the first network 101, e.g. between the UE 120, a Visited AMF (AMF) 400b, a Visited PCF (vPCF) 400c, a Home PCF (hPCF) 400e, and/or a UDM 400f. The core network node 110 may e.g. comprise any of the AMF 400b and/or vPCF 400c. In this example the one or more rules are referred to as policies or policies/rules, and the core network node 130 is represented by the AMF 400b.

The example in the sequence diagram may comprise the following actions.
In action 401, the UE 120 registers 401 in 5G System (5GS). The registration may comprise sending a registration request to the AMF 400b. The registration request may comprise Requested S-NSSAI and/or UE 120 Capabilities e.g. including support for Slice Use policies. In one example (but there are other ways of doing this), the UE 120 includes its capability data relating to the UE's 120 capabilities to support rules for use of network slices and possibly DNN/PDU Session. The UE MM Core Network Capability, i.e. in the UE 5GMM Core Network Capability, may be extended to include this information. This relates to and may be combined with actions 201 and 301 as described above.
In action 402, Registration procedure steps 2-19c are performed 402 e.g. according to 3GPP TS 23.502 with the additional possible need to store the new UE 120 capabilities. If the option of V-PCF is to provide the policies, the Access and mobility related policy information may be extended such that the AMF 400b provides to the V-PCF 400c the Configured NSSAI and DNNs e.g. in the Npcf_AMPolicyControl_Create, see TS 23.502 step 2 of FIG. 4.16.1.2-1, or the Npcf_AMPolicyControl_Update, see TS 23.502 step 1 of FIG. 4.16.2.1.1-1, and the V-PCF 400c derives the related policies and provides them in the response. The V-PCF 400c may later on update the policies in Npcf_AMPolicyControl_UpdateNotify, see TS 23.502 step 3 of FIG. 4.16.2.2-1. This relates to and may be combined with action 202 as described above.
In action 403, if/when the AMF 400b is not configured for the policies for the Allowed slices, and the option of V-PCF is not used, the AMF 400b may send 403 a Nnssf_NSSelection_Get Request to the NSSF to either fetch Network Slice selection information and policies or just the policies applicable to allowed slices usage (e.g. all S-NSSAIs of Configured NSSAI). The Request may be extended to include the request of network slice usage policies for Allowed slices/Configured Slices. Alternatively a new NSSF service operation is used to retrieve the policies in which case the AMF 400b provides the applicable S-NSSAIs e.g. all S-NSSAIs of the Configured NSSAI, PLMN ID of the UE or complete UE ID e.g. Subscription Permanent Identifier (SUPI), and the related DNNs of the S-NSSAIs.
In action 404, a Nnssf_NSSelection_Get Response is received 404. The Nnssf_NSSelection_Get Response is extended to include additional network slice usage policies/rules information, e.g. allowed slice usage policies. Or, as an alternative, a response of a new service operation is received. This relates to and may be combined with action 203 as described above.
In action 405, the AMF 400b stores the received information, and validates 405, e.g. checks, and decides, if the UE 120 supports the ability to store and process network slice usage policies/rules, unless that was done before in action 402 or before action 403. For example, the AMF 400b may validate UE 120 capabilities to receive network slice UE 120 policies. Allowed slice policies may be stored as part of the UE context stored in the core network node 130 such as its AMF. This relates to and may be combined with action 204 as described above.
In action 406, assuming it has been decided that the UE 120 supports the policies, the AMF 400b includes this information in the Registration Accept response to the UE 120. The registration accept response is received 406 by the UE 120. The response may comprise an indication of allowed NSSAI and/or network policies governing use of allowed NSSAI or rules per network slice, S-NSSAI of the allowed NSSAI or Configured NSSAI. This relates to and may be combined with actions 205 and 302 as described above.
In action 407, the UE 120 applies 407 the received network slice rules/policies. This relates to and may be combined with action 303 as described above.
In action 408, the AMF 400b enforces 508 the policies. The AMF 400b actions in case of policy violation is out of scope of embodiments herein. This relates to and may be combined with action 206 as described above.

In case the network wants to update the polices, the AMF 400b provides the updated policies to the UE 120 using UE Configuration Update Command, e.g. as in 3GPP TS 23.502 FIGS. 4.2.4.2-1.

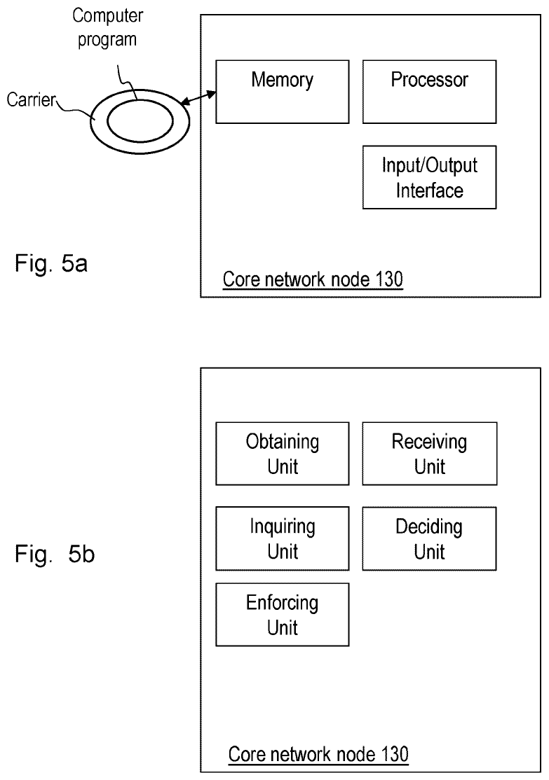

FIGS. 5a and 5b shows an example of arrangement in the core network node 130.

The core network node 130 may comprise an input and output interface configured to communicate with other network entities, e.g., the UE 120. The input and output interface may comprise a receiver, e.g., wired and/or wireless, (not shown) and a transmitter, e.g., wired and/or wireless, (not shown).

The core network node 130 may comprise any one or more out of: An obtaining unit, an inquiring unit, a receiving unit, a deciding unit, and an enforcing unit, to perform the method actions as described herein.

The embodiments herein may be implemented through a respective processor or one or more processors, such as at least one processor of a processing circuitry in the core network node 130 depicted in FIG. 5a, together with computer program code for performing the functions and actions of the embodiments herein. The program code mentioned above may also be provided as a computer program product, for instance in the form of a data carrier carrying computer program code for performing the embodiments herein when being loaded into the core network node 130. One such carrier may be in the form of a CD ROM disc. It is however feasible with other data carriers such as a memory stick. The computer program code may furthermore be provided as pure program code on a server and downloaded to the core network node 130.

The core network node 130 may further comprise respective a memory comprising one or more memory units. The memory comprises instructions executable by the processor in the core network node 130. The memory is arranged to be used to store instructions, data, configurations, and applications to perform the methods herein when being executed in the core network node 130.

In some embodiments, a computer program comprises instructions, which when executed by the at least one processor, cause the at least one processor of the core network node 130 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the core network node 130, described below may refer to a combination of analog and digital circuits, and/or one or more processors configured with software and/or firmware, e.g. stored in the core network node 130, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

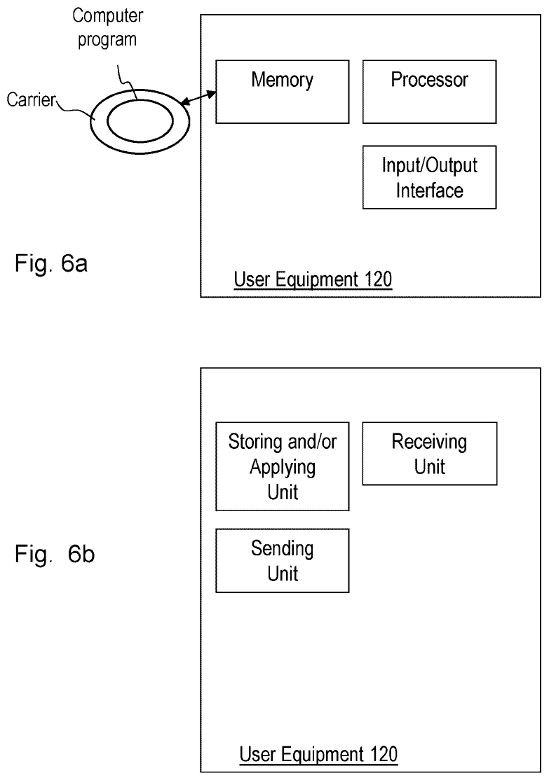

FIGS. 6a and 6b shows an example of arrangement in the UE 120.

The UE 120 may comprise an input and output interface configured to communicate with other network entities, e.g., the core network node 130. The input and output interface may comprise a receiver, e.g., wired and/or wireless, (not shown) and a transmitter, e.g., wired and/or wireless, (not shown).

The UE 120 may comprise any one or more out of: A storing and/applying unit, a sending unit, and a receiving unit, to perform the method actions as described herein.

The embodiments herein may be implemented through a respective processor or one or more processors, such as at least one processor of a processing circuitry in the UE 120 depicted in FIG. 6a, together with computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as a memory stick. The computer program code may furthermore be provided as pure program code on a server and downloaded to the UE 120.

The UE 120 may further comprise respective a memory comprising one or more memory units. The memory comprises instructions executable by the processor in the UE 120. The memory is arranged to be used to store instructions, data, configurations, and applications to perform the methods herein when being executed in the UE 120.

In some embodiments, a computer program comprises instructions, which when executed by the at least one processor, cause the at least one processor of the UE 120 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the UE 120, described below may refer to a combination of analog and digital circuits, and/or one or more processors configured with software and/or firmware, e.g. stored in the UE 120, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above-described preferred embodiments. Various alternatives, modifications and equivalents may be used.

### Embodiments

Below, some example embodiments 1-16 are shortly described. See e.g. FIGS. 1, 2, 3, 4, 5a, 5b, 6a, and 6b.

Embodiment 1. A method performed by a core network node 130, e.g. an AMF node, for handling one or more rules for a User Equipment, UE, 120 in a network 101, 102, and where the core network node 130 is operating in the network 101, 102, and wherein the network 101, 102 is comprised in a wireless communications network 100, the method comprising any one or more out of:
receiving 201 capability data from the UE 120, which capability data relates to the UE's 120 capabilities to support rules for use of one or more network slices,
obtaining 203 one or more rules relating to a use of one or more network slices allowed in the network 101, 102,
deciding 204 that the UE 120 is capable to support rules for use of one or more network slices in the network 101, 102 according to the one or more rules, based on the received capability data and the obtained one or more rules,
sending 205 to the UE 120, the one or more rules that the UE 120 is capable to support, and where the one or more rules are to be applied by the UE 120 for use of one or more network slices in the network 101, 102,
enforcing 206 the one or more rules relating to the of use of one or more network slices applied by the UE 120 in the network 101, 102, which enforcing e.g. comprises detection of rules violation.

Embodiment 2. The method according to Embodiment 1, wherein the network 101, 102 is represented by any one out of:
a Home Public Land Mobile Network, HPLMN,
a Visited Public Land Mobile Network, VPLMN, or
a Standalone Non-Public Network, SNPN,

Embodiment 3. The method according to any of the Embodiments 1-2, further comprising:
inquiring 202 the one or more rules relating to the use of the one or more network slices allowed in the network 101, 102, wherein the one or more rules are inquired from any one out of: a policy control node, e.g. a Visited Policy Control Function, V-PCF, or a Network Slice Selection Function NSSF node, and
wherein the one or more rules are obtained 203 from the corresponding any one out of: the policy control node or the NSSF node.

Embodiment 4. The method according to any of the Embodiments 1-2, wherein the one or more rules are obtained 203 by being configured in the core network node 130.

Embodiment 5. A computer program comprising instructions, which when executed by a processor, causes the processor to perform actions according to any of the Embodiments 1-4.

Embodiment 6. A carrier comprising the computer program of Embodiment 5, wherein the carrier is one of an electronic signal, an optical signal, an electromagnetic signal, a magnetic signal, an electric signal, a radio signal, a microwave signal, or a computer-readable storage medium.

Embodiment 7. A method performed by a User Equipment, UE, 120, e.g., for handling one or more rules in a network 101, 102, which network 101, 102 is comprised in a wireless communications network 100, the method comprising any one or more out of:
sending 301 to a core network node 130 operating in the network 101, 102, e.g. an AMF node capability data relating to the UE's 120 capabilities to support rules related to a use of one or more network slices,
receiving 302 from the core network node 130, one or more rules relating to the of use of one or more network slices, wherein the core network node 130 has decided that the UE 120 is capable to support the one or more rules based on the sent capability data and one or more rules allowed in the network 101, 102,
storing and/or applying 303 the received one or more rules in the network 101, 102.

Embodiment 8. The method according to Embodiment 7, wherein the network 101, 102 is represented by any one out of:
a Home Public Land Mobile Network, HPLMN,
a Visited Public Land Mobile Network, VPLMN, or
a Standalone Non-Public Network, SNPN.

Embodiment 9. A computer program comprising instructions, which when executed by a processor, causes the processor to perform actions according to any of the Embodiments 7-8.

Embodiment 10. A carrier comprising the computer program of Embodiment 9, wherein the carrier is one of an electronic signal, an optical signal, an electromagnetic signal, a magnetic signal, an electric signal, a radio signal, a microwave signal, or a computer-readable storage medium.

Embodiment 11. A core network node 130, e.g. an AMF node, configured to handle one or more rules for a User Equipment, UE, 120 in a network 101, 102, which core network node 130 is operable in the network 101, 102, and wherein the network 101, 102 is adapted to be comprised in a wireless communications network 100, the core network node 130 further being configured to any one or more out of:
receive, e.g. by means of a receiving unit comprised in the core network node 130, capability data from the UE 120, which capability data is adapted to relate to the UE's 120 capabilities to support rules for use of one or more network slices,
obtain, e.g. by means of an obtaining unit comprised in the core network node 130, one or more rules relating to a use of one or more network slices allowed in the network 101, 102,
decide, e.g. by means of a deciding unit comprised in the core network node 130, that the UE 120 is capable to support rules for use of one or more network slices in the network 101, 102 according to the one or more rules, based on the received capability data and the obtained one or more rules,
send to the UE 120, e.g. by means of a sending unit comprised in the core network node 130, the one or more rules that the UE 120 is capable to support, which one or more rules are adapted to be applied by the UE 120 for use of one or more network slices in the network 101, 102,
enforce, e.g. by means of a enforcing unit comprised in the core network node 130, the one or more rules relating to the of use of one or more network slices applied by the UE 120 in the network 101, 102, which enforce e.g. comprises detection of rules violation.

Embodiment 12. The core network node 130 according to Embodiment 11, wherein the network 101, 102 is adapted to be represented by any one out of.
a Home Public Land Mobile Network, HPLMN,
a Visited Public Land Mobile Network, VPLMN, or
a Standalone Non-Public Network, SNPN.

Embodiment 13. The core network node 130 according to any of the Embodiments 11-12, further being configured to:
inquire, e.g. by means of the inquiring unit comprised in the core network node 130, the one or more rules relating to the use of the one or more network slices allowed in the network 101, 102, wherein the one or more rules are to be inquired from any one out of: a policy control node, e.g. a Visited Policy Control Function, V-PCF, or a Network Slice Selection Function NSSF node, and
wherein the one or more rules are adapted to be obtained, e.g. by means of the obtaining unit comprised in the core network node 130, from the corresponding any one out of: the policy control node or the NSSF node.

Embodiment 14. The core network node 130 according to any of the Embodiments 11-12, wherein the one or more rules are adapted to be obtained, e.g. by means of the obtaining unit comprised in the core network node 130, by being configured in the core network node 130.

Embodiment 15. A User Equipment, UE, 120, e.g., configured to handle one or more rules in a network 101, 102, wherein the network 101, 102 is adapted to be comprised in a wireless communications network 100, the UE 120 further being configured to any one or more out of:
send, e.g. by means of a sending unit comprised in the UE 120, to a core network node 130 operating in the network 101, 102, e.g. an AMF node capability data relating to the UE's 120 capabilities to support the use of rules related to the use of one or more network slices,
receive, e.g. by means of a receiving unit comprised in the UE 120, from the core network node 130, one or more rules relating to the of use of one or more network slices, which one or more rules are adapted to have been decided that the UE 120 is capable to support, which one or more rules are adapted to be decided based on the sent capability data and one or more rules allowed in the network 101, 102,
store and/or apply, e.g. by means of a storing and/or applying unit comprised in the UE 120, the received one or more rules in the network 101, 102.

Embodiment 16. The UE 120 according to Embodiment 15, wherein the network 101, 102 is adapted to be represented by any one out of.
a Home Public Land Mobile Network, HPLMN,
a Visited Public Land Mobile Network, VPLMN, or
a Standalone Non-Public Network, SNPN.

### Further Extensions and Variations

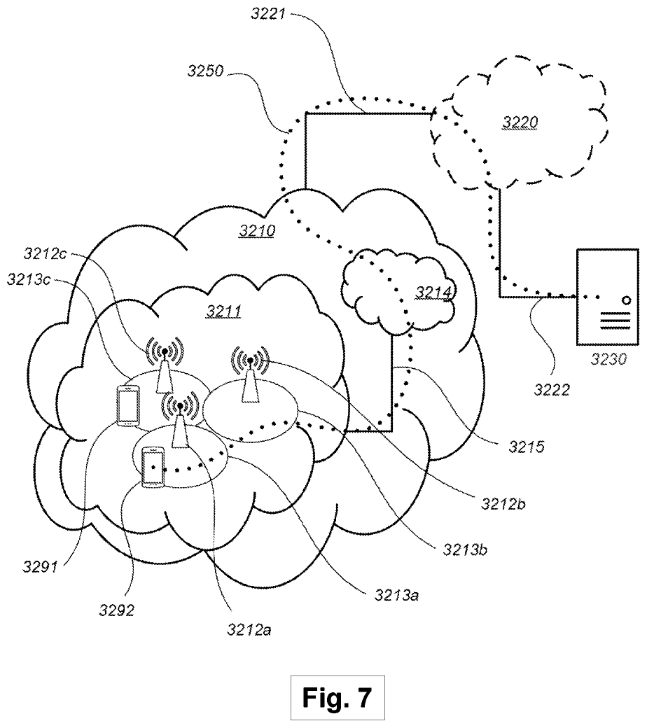

With reference to FIG. 7, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, e.g. the core network node 130, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 120 such as a Non-AP STA 3291 located in coverage area 3213c is configured to wirelessly connect to, or be paged by, the corresponding base station 3212c. A second UE 3292 e.g. the UE 120 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

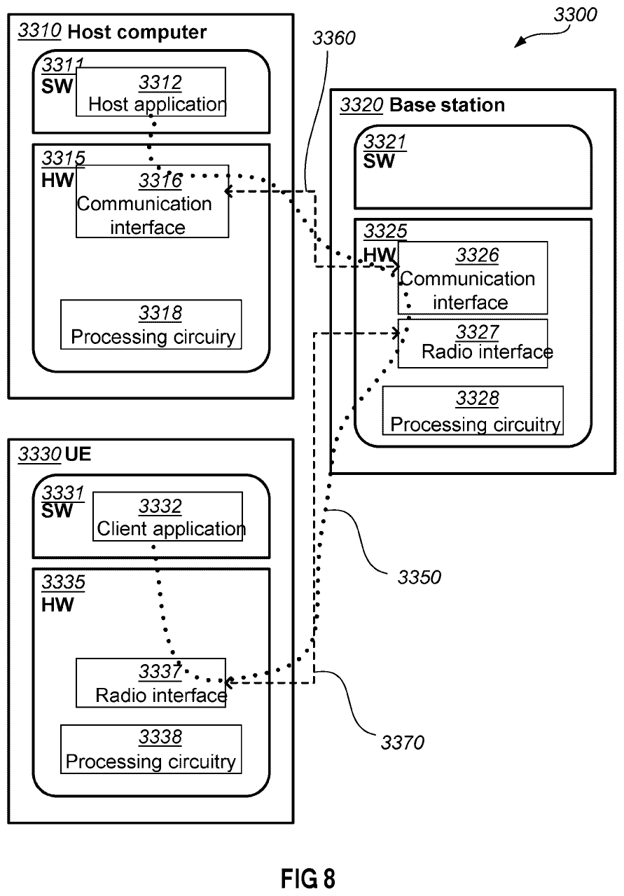

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

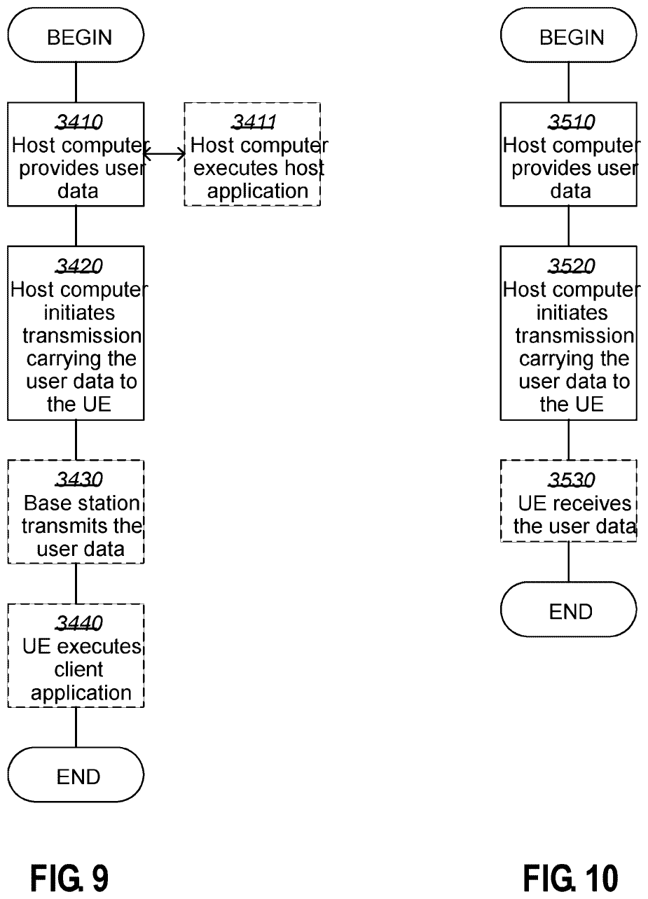

FIG. 9 is a flowchart illustrating a method implemented in a communication system, in accordance with one embodiment. The communication system includes a host computer, a base station e.g. the core network node 130, and a UE such as the UE 120, which may be those described with reference to FIG. 7 and FIG. 8. For simplicity of the present disclosure, only drawing references to FIG. 9 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 10 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

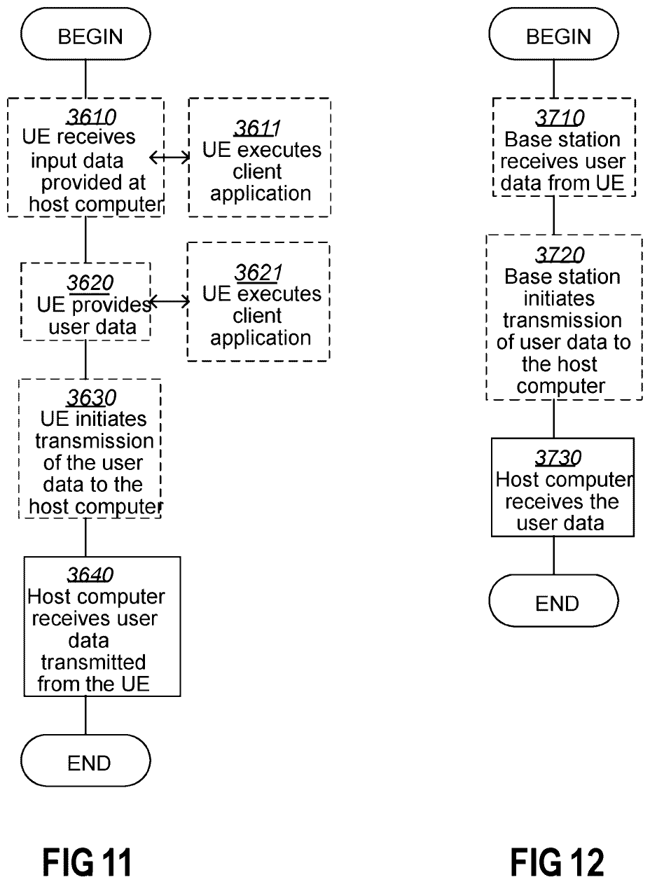

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 11 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 12 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

1. A method performed by a core network node (130) for handling one or more rules for a User Equipment, UE, (120) in a network (101, 102), and where the core network node (130) is operating in the network (101, 102), and wherein the network (101, 102) is comprised in a wireless communications network (100), the method comprising:
receiving (201) capability data from the UE (120), which capability data relates to the UE's (120) capabilities to support rules for use of one or more network slices,
obtaining (203) one or more rules relating to a use of one or more network slices allowed in the network (101, 102),
deciding (204) that the UE (120) is capable to support rules for use of one or more network slices in the network (101, 102) according to the one or more rules, based on the received capability data and the obtained one or more rules,
sending (205) to the UE (120), the one or more rules that the UE (120) is capable to support, and where the one or more rules are to be applied by the UE (120) for use of one or more network slices in the network (101, 102),
enforcing (206) the one or more rules relating to the of use of one or more network slices applied by the UE (120) in the network (101, 102).

2. The method according to claim 1, wherein the network (101, 102) is represented by any one out of:
a Home Public Land Mobile Network, HPLMN,
a Visited Public Land Mobile Network, VPLMN, or
a Standalone Non-Public Network, SNPN,

3. The method according to claim 1, further comprising:
inquiring (202) the one or more rules relating to the use of the one or more network slices allowed in the network (101, 102), wherein the one or more rules are inquired from any one out of: a policy control node or a Network Slice Selection Function NSSF node, and
wherein the one or more rules are obtained (203) from the corresponding any one out of: the policy control node or the NSSF node.

4. The method according to claim 1, wherein the one or more rules are obtained (203) by being configured in the core network node (130).

5. A computer program comprising instructions, which when executed by a processor, causes the processor to perform actions according to claim 1.

6. A carrier comprising the computer program of claim 5, wherein the carrier is one of an electronic signal, an optical signal, an electromagnetic signal, a magnetic signal, an electric signal, a radio signal, a microwave signal, or a computer-readable storage medium.

7. A method performed by a User Equipment, UE, (120), for handling one or more rules in a network (101, 102), which network (101, 102) is comprised in a wireless communications network (100), the method comprising:
sending (301) to a core network node (130) operating in the network (101, 102), capability data relating to the UE's (120) capabilities to support rules related to a use of one or more network slices,
receiving (302) from the core network node (130), one or more rules relating to the of use of one or more network slices, wherein the core network node (130) has decided that the UE (120) is capable to support the one or more rules based on the sent capability data and one or more rules allowed in the network (101, 102),
storing and applying (303) the received one or more rules in the network (101, 102).

8. The method according to claim 7, wherein the network (101, 102) is represented by any one out of:
a Home Public Land Mobile Network, HPLMN,
a Visited Public Land Mobile Network, VPLMN, or
a Standalone Non-Public Network, SNPN.

9. A computer program comprising instructions, which when executed by a processor, causes the processor to perform actions according to claim 7.

10. A carrier comprising the computer program of claim 9, wherein the carrier is one of an electronic signal, an optical signal, an electromagnetic signal, a magnetic signal, an electric signal, a radio signal, a microwave signal, or a computer-readable storage medium.

11. A core network node (130), configured to handle one or more rules for a User Equipment, UE, (120) in a network (101, 102), which core network node (130) is operable in the network (101, 102), and wherein the network (101, 102) is adapted to be comprised in a wireless communications network (100), the core network node (130) further being configured to:
receive capability data from the UE (120), which capability data is adapted to relate to the UE's (120) capabilities to support rules for use of one or more network slices,
obtain one or more rules relating to a use of one or more network slices allowed in the network (101, 102),
decide that the UE (120) is capable to support rules for use of one or more network slices in the network (101, 102) according to the one or more rules, based on the received capability data and the obtained one or more rules,
send to the UE (120), the one or more rules that the UE (120) is capable to support, which one or more rules are adapted to be applied by the UE (120) for use of one or more network slices in the network (101, 102),
enforce the one or more rules relating to the of use of one or more network slices applied by the UE (120) in the network (101, 102).

12. The core network node (130) according to claim 11, wherein the network (101, 102) is adapted to be represented by any one out of.
a Home Public Land Mobile Network, HPLMN,
a Visited Public Land Mobile Network, VPLMN, or
a Standalone Non-Public Network, SNPN.

13. The core network node (130) according to claim 11, further being configured to:
inquire the one or more rules relating to the use of the one or more network slices allowed in the network (101, 102), wherein the one or more rules are to be inquired from any one out of: a policy control node or a Network Slice Selection Function NSSF node, and
wherein the one or more rules are adapted to be obtained from the corresponding any one out of: the policy control node or the NSSF node.

14. The core network node (130) according to claim 11, wherein the one or more rules are adapted to be obtained by being configured in the core network node (130).

15-16. (canceled)
